(19) United States
(12) Patent Application Publication
(10) Pub. No.: US 2012/0118838 A1
(43) Pub. Date: May 17, 2012

(54) SHOE TRAVELER OR FOOTWEAR TRAVELER

(76) Inventor: YVONNE DNISE GUTIERREZ, NAPLES, FL (US)

(21) Appl. No.: 12/944,696

(22) Filed: Nov. 11, 2010

(51) Int. Cl. A47B 81/00; B23P 17/04

(52) U.S. Cl. 211/34; 29/428

(57) ABSTRACT

In one embodiment of the invention, an apparatus includes a portable item storage device, a rack that is disposed in the portable item storage device, a first shoe spacer, and a second shoe spacer. Each shoe spacer is removably coupled to the rack and adjustable in size.

### TECHNICAL FIELD

Embodiments of the invention relate generally to a shoe traveler or footware traveler.

### BACKGROUND

It is difficult for traveling persons to pack footwear such as various types of shoes (e.g., men's shoes, women's shoes, children's shoes, athletic shoes, dress shoes, walking shoes, and the like) due to various problems. First, it is difficult to find a luggage space for shoes in a luggage that has been packed with clothing and other travel items. Second, it is difficult to protect the shoes from, for example, being scuffed, being crushed, or deformation (where the shoes lose their shape for wearing), when the shoes are in contact (or rub together) with each other in the packed state. When the shoes rub against each other, the shoes often receive scuffed marks or become deformed. Third, the shoes can cause damage or dirt stains (or water stains) with the neighboring clothes in the packed state, and vice versa. Fourth, by placing the shoes in a luggage, less space is available for clothing and other travel items in the luggage space.

Therefore, the current technology is limited in its capabilities and suffers from at least the above constraints and deficiencies.

### SUMMARY

In one embodiment of the invention, an apparatus includes a portable item storage device, a rack that is disposed in the portable item storage device, a first shoe spacer, and a second shoe spacer. Each shoe spacer is removably coupled to the rack and adjustable in size. The portable item storage device is, for example, a luggage.

In another embodiment of the invention, a method of assembling a footware traveler includes: providing a rack including a horizontal member and vertical members; attaching the vertical members on a sliding member; mounting the sliding member on a base member; attaching brackets on the horizontal member; providing shoe spacers; and attaching an attachment mechanism on the brackets and the shoe spacers, wherein the shoe spacers are removably coupled to the rack by the attachment mechanism.

In yet another embodiment of the invention, an apparatus includes: a rack; and a first shoe spacer and a second shoe spacer, each shoe spacer removably coupled to the rack and adjustable in size.

In yet another embodiment of the invention, an apparatus includes: a rack; first means for providing a shoe spacer; and second means for providing a shoe spacer, each of said first means and second means coupled to the rack and adjustable in size.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 is a side view of an apparatus in accordance with an embodiment of the invention.

FIG. 2 is a side view of an apparatus in accordance with an embodiment of the invention, where the shoes are not yet secured by the shoe spacers.

FIG. 3 is a side view of an apparatus in accordance with an embodiment of the invention, where the shoes have been secured by the shoe spacers.

FIG. 4 is a side view of a rack in accordance with an embodiment of the invention.

FIG. 5 is a top view of an apparatus in accordance with another embodiment of the invention.

FIG. 6 is a side view of a shoe spacer in accordance with an embodiment of the invention.

FIG. 7 is a top view of the shoe spacer of FIG. 6, in accordance with an embodiment of the invention.

FIG. 8 is a bottom view of the shoe spacer of FIG. 6, in accordance with an embodiment of the invention.

FIG. 9 is a side view of the shoe spacer of FIG. 6 in accordance with an embodiment of the invention, where the size of the shoe spacer has been adjusted.

FIG. 10 is a cross-section view of a shoe piece with a shoe spacer that is removably inserted and removably secured in the shoe piece, in accordance with an embodiment of the invention.

FIG. 11 is a side view of a men-shoe type that is removably secured to a shoe spacer and bracket in a rack, in accordance with an embodiment of the invention.

FIG. 12 is a side view of a children-shoe type that is removably secured to a shoe spacer and bracket in a rack, in accordance with an embodiment of the invention.

FIG. 13 is a side view of an athletic-shoe type that is removably secured to a shoe spacer and bracket in a rack, in accordance with an embodiment of the invention.

FIG. 14 is a side view of an attachment mechanism for removably coupling the shoe spacer with the rack, in accordance with an embodiment of the invention.

FIG. 15 is a side view of an attachment mechanism for removably coupling the shoe spacer with the rack, in accordance with another embodiment of the invention.

FIG. 16 is a side view of an attachment mechanism for removably coupling the shoe spacer with the rack, in accordance with another embodiment of the invention.

FIG. 17 is a side view of a rack in accordance with another embodiment of the invention.

FIG. 18A is a side view of a shoe spacer in accordance with another embodiment of the invention.

FIG. 18B is a side view of a men-shoe type that is removably secured to a shoe spacer and bracket in a rack, in accordance with another embodiment of the invention.

FIG. 18C is a side view of an athletic-shoe type that is removably secured to a shoe spacer and bracket in a rack, in accordance with another embodiment of the invention.

FIG. 18D is a side view of a women-shoe type that is removably secured to a shoe spacer and bracket in a rack, in accordance with another embodiment of the invention.

FIG. 19 is a side view of a rack in accordance with another embodiment of the invention.

### DETAILED DESCRIPTION OF PREFERRED EMBODIMENTS

In the description herein, numerous specific details are provided, such as examples of components, parts, structures, and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, structures, and/or the like. In other instances, well-known structures, materials, or operations are not shown or described in detail to avoid obscuring aspects of embodiments of the invention. Additionally, the figures are representative in nature and their shapes are not intended to illustrate the precise shape or precise size of any element and are not intended to limit the scope of the invention.

Those skilled in the art will understand that when an element or part in the drawings is referred to as being “on” (or “coupled” to or “attached” to) another element, it can be directly on (or attached to) the other element or intervening elements may also be present. Furthermore, relative terms such as “inner”, “outer”, “upper”, “above”, “lower”, “beneath”, and “below”, and similar terms, may be used herein to describe a relationship of one element or another element. It is understood that these terms are intended to encompass different orientations of the device in addition to the orientation depicted in the figures.

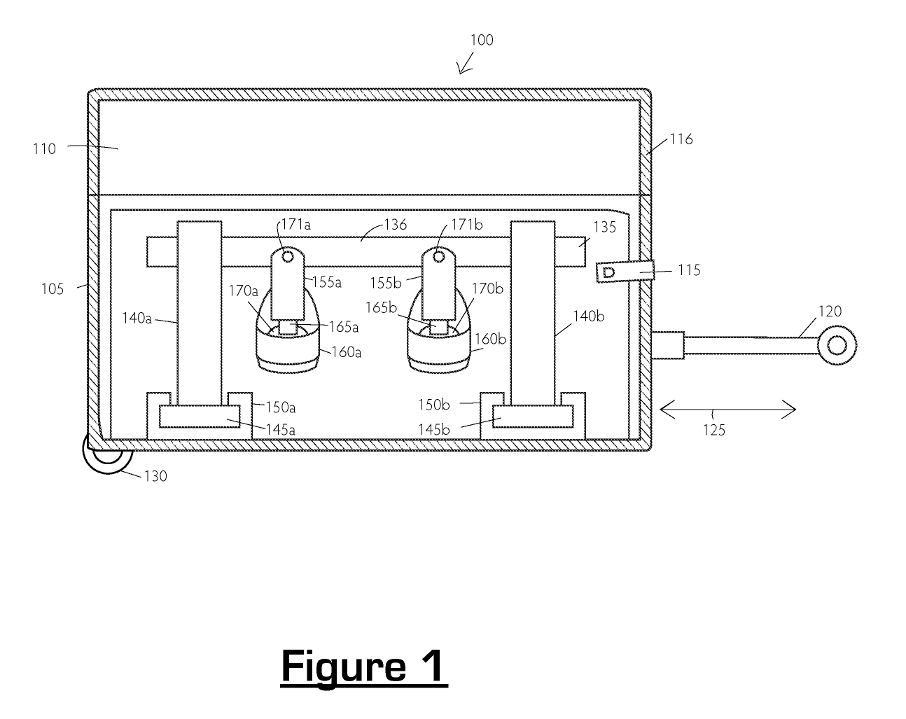

Although the terms first, second, and the like may be used herein to describe various elements, components, regions, layers and/or sections, these elements, components, parts, regions, layers, and/or sections should not be limited by these terms. These terms are only used to distinguish one element, component, part, region, layer, or section from another component, part, region, layer, or section. Thus, a first element, component, part, region, layer, or section discussed below could be termed a second element, component, part region, layer, or section without departing from the teachings of the present invention. Embodiments of the invention are described herein with reference to cross-sectional view illustrations that are schematic illustrations of representative embodiments of the invention. As such, variations from the shapes of the illustrations as a result, for example, of manufacturing techniques and/or tolerances are expected. Embodiments of the invention should not be construed as limited to the particular shapes of the regions illustrated herein but are to include deviations in shapes that result, for example, from manufacturing or particular implementations. An element illustrated or described as square or rectangular may typically have rounded or curved features due to normal manufacturing tolerances or due to a particular implementation. Thus, the elements illustrated in the figures are schematic in nature and their shapes are not intended to illustrate the precise shape of an element of a device and are not intended to limit the scope of the invention. FIG. 1 is a side view of an apparatus 100 in accordance with an embodiment of the invention. The apparatus 100 is a shoe traveler (or footware traveler) that provides various benefits such as, for example, protecting or maintaining the form (e.g., shape), and structure of a shoe in a packed/packaged state, preventing scuff marks on shoes, protecting the shoes from damage, preventing dirt stains (or water stains or other stains) on the shoes, minimizing wear-and-tear on the shoes, preventing damage, dirt stains, water stains and other stains (e.g., color stains) on clothes that were previously packed in the same luggage as the shoes, allowing more space in another luggage packed with clothing because the shoes are instead packed in the shoe traveler, and providing portability and convenience for travelers. The apparatus (shoe traveler or footware traveler) 100 is useful for anyone who travels for vacations, for business, to family reunions, to local destinations (e.g., from home to the gym, school, rehearsals, photo-events, or other destinations, and vice versa), or for other travels.

In an embodiment of the invention, the shoe traveler (footware traveler or apparatus) 100 includes a luggage 105 (i.e., portable item storage device 105) for shoes. FIG. 1 shows the luggage 105 with a luggage cover 110 that can close (zip-up) the luggage 105 by use of, for example, a zipper 115 and a zipper track 116. However, other types of suitable mechanisms may be used in place of the zipper 115 (and zipper track 116) to open and close the luggage 105, such as, for example, buttons, Velcro, or other locking mechanisms that can removably secure the luggage cover 110 to the luggage 105.

In an embodiment of the invention, the luggage 105 can include, for example, a handle 120 that can be extended and compressed in the direction 125 and wheels 130 that aid in the portability of the luggage. However, in another embodiment of the invention, the luggage can instead be a duffle bag or other types of suitable portable item storage device. The material for the walls (sides) of the luggage 105 can be any conventional material used for any luggage or similar-function devices.

In an embodiment of the invention, the luggage 105 includes a rack 135 which also includes the horizontal member 136 and vertical members 140a and 140b. The rack 135 is disposed within or inside the luggage 105. The vertical members 140a and 140b are on the sliding members 145a and 145b, respectively. The sliding members 145a and 145b can slide along the base members 150a and 150b, respectively, so that the rack 135 can slide into and out of the luggage 105 and the rack 135 is slidable at various positions with respect to the luggage 105, as will be discussed further below.

In an embodiment of the invention, the rack 135 includes the brackets 155a and 155b that can removably secure or (removably hold) the shoes 160a and 160b, respectively. The bracket 155a is removably coupled by the attachment mechanism 165a to a shoe spacer 170a. Two components that are removably coupled (or removably attached or removably secured or removably inserted) means that the two different components can be attached together and detached apart. Similarly, the bracket 155b is removably coupled by the attachment mechanism 165b to a shoe spacer 170b. Different types of suitable attachment mechanisms 165a/165b will be discussed below.

The brackets 155a and 155b are coupled to the horizontal member 136 (of rack 135) by attachment mechanisms 171a and 171b, respectively. The attachment mechanisms 171a/171b are, for example, bolts, screws, glue, or other suitable attachment mechanisms or attachment methods. In another embodiment, the brackets 155a/155b are integrated into the rack 135, so that the rack 135 and brackets 155a/155b are a single integrated part. This integrated rack-brackets part can be formed by, for example, molding or other manufacturing methods that are known to those skilled in the art.

The shoe spacer 170a is first removed from the bracket 155a by detaching the attachment mechanism 165a apart as will be discussed further below. The detached shoe spacer 170a is then inserted into the shoe piece 160a so that the shoe spacer 170a is removably secured or removably securable to the shoe piece 160a. The shoe spacer 170a is then re-attached to the bracket 155a by re-attaching the attachment mechanism 165a together as will be discussed further below. As a result, the shoe spacer 170a is holding the shoe piece 160a, and the rack 135 holds the shoe piece 160a in place (in a static position or non-moving position) since the shoe piece 160a is attached to the rack 135 along the bracket 155a, attachment mechanism 165a, and the shoe spacer 170a.

Similarly, the shoe spacer 170b is removably secured or removably securable to the shoe piece 160b. The shoe spacer 170b is holding the shoe piece 160b, and the rack 135 holds the shoe piece 160b in place (in a static position or non-moving position) since the shoe piece 160b is attached to the rack 135 along the bracket 155b, attachment mechanism 165b, and the shoe spacer 170b. Since the shoes 160a/160b are held in place in the shoe traveler 100, the above-discussed advantages and benefits (e.g., preventing damage, scuffing, and deformation of the shoes, and protection of shoes and optimized packing of items for the travelling individual) are achieved.

The rack 135 (including the horizontal member 136 and vertical members 140a/140b), brackets 155a/155b, slidable members 145a/145b, and base members 150a/150b can be constructed, assembled, and/or manufactured from any suitable conventional materials as known to those skilled in the art. For example, the rack 135, brackets 155a/155b and/or members 145a/145b and 150a/150b can be constructed from wood, durable plastic, metal, metal alloys, or combinations of these and other materials. As a specific example, the rack 135 is constructed from wood, metal, metal alloys, or durable plastic, and the brackets 155a/155b and/or members 145a/145b and 150a/150b are constructed from metal, metal alloys, or durable plastic. Those skilled in the art will realize that other suitable materials or combination of suitable materials can be used for the components in the shoe traveler 100.

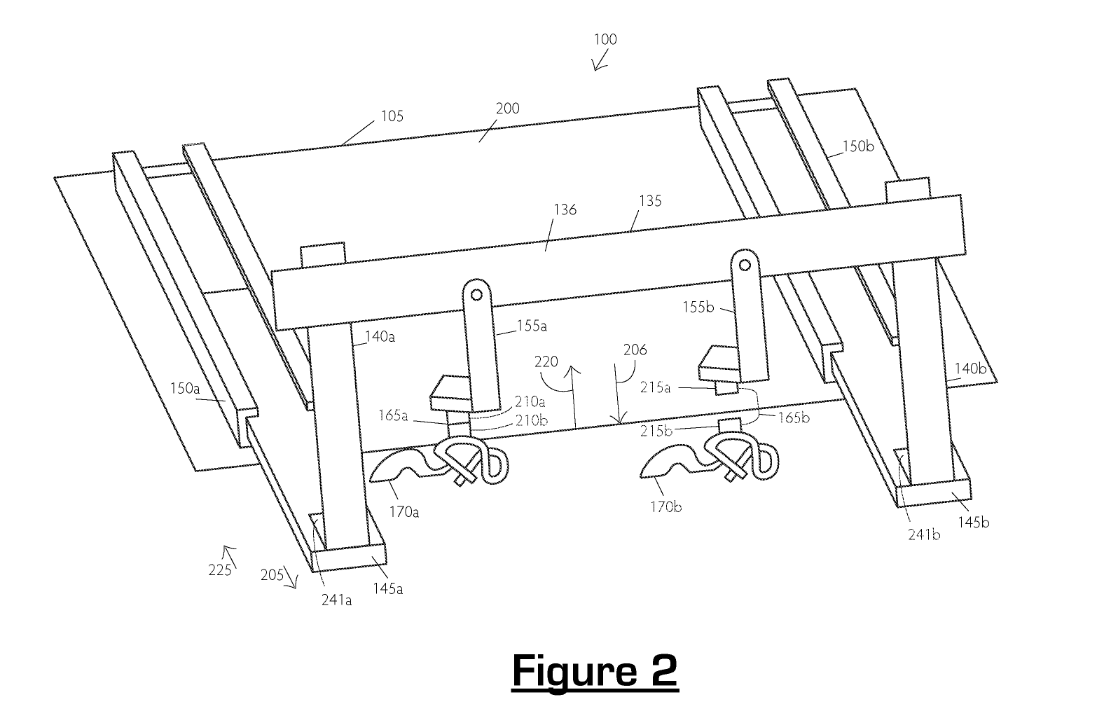

FIG. 2 is a side view of an apparatus 100 in accordance with an embodiment of the invention, where the shoe pieces 160a and 160b (FIG. 1) are not yet respectively secured by the shoe spacers 170a and 170b, respectively. Generally, the user of apparatus 100 would first unzip (open) the luggage 105, slide out (pull out) the rack 135 from the luggage 105, detach the shoe spacers 170a and 170b from the respective brackets 155a and 155b, insert the shoe spacers 170a and 170b into the shoe pieces 160a and 160b, respectively, re-attach the shoe spacers 170a and 170b to the respective brackets 155a and 155b of the rack 135, slide in (push back) the rack 135 into the luggage 105, and zip-up (close) the luggage 105.

For purposes of clarity, only one side (or wall) 200 of the luggage 105 is shown in FIG. 2. The base members 150a and 150b are removably coupled to (or permanently coupled to) the side 200 (of luggage 105) by use of any suitable attachment mechanisms such as, for example, glue, Velcro, or other suitable attachment mechanisms or methods. The user of the luggage 105 will unzip (open) the luggage 105 by use of the zipper 115 (FIG. 1). The user then slides out (pulls out) the rack 135, and this movement will cause the sliding members 145a and 145b to slide away from the base members 150a and 150b, respectively, in the outward direction 205. The user detaches the shoe spacers 170a and 170b from the brackets 155a and 155b, respectively, by detaching (in direction 206) the component 210b from component 210a (both forming the attachment member 165a) and by detaching the component 215b from component 215a (both forming the attachment member 165b). The attachment member 165b is shown with the components 215a and 215b as being detached from each other.

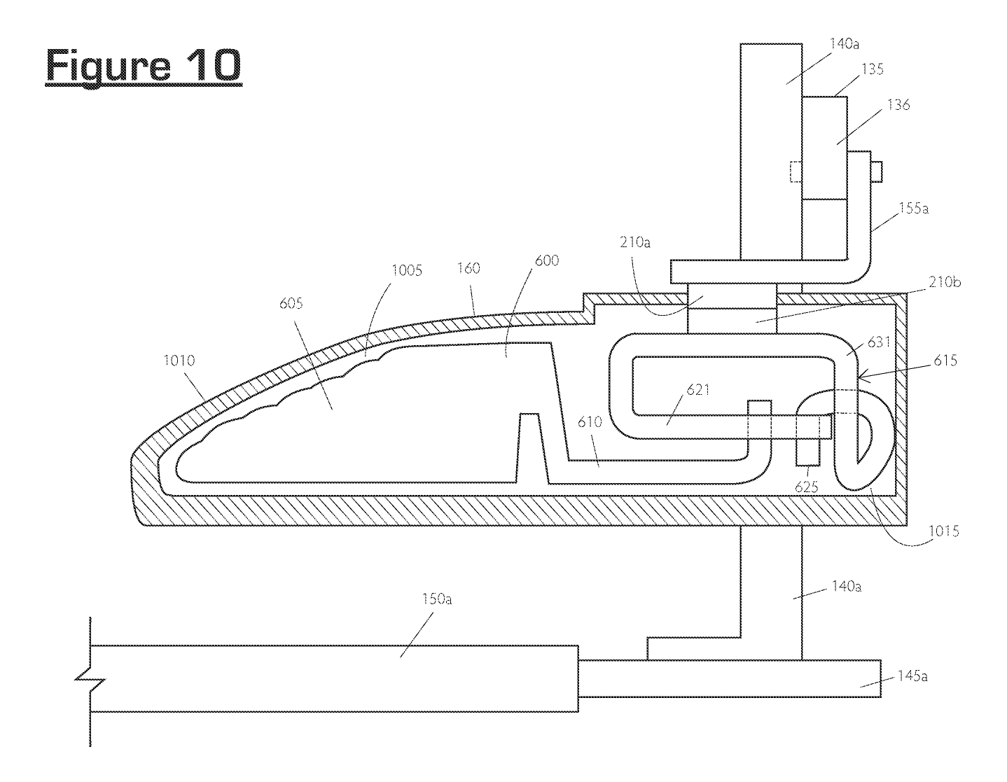

The user then inserts the shoe spacers 170a and 170b into the shoe pieces 160a and 160b, respectively. As discussed below, FIG. 10 shows an example of a shoe spacer that is removably inserted and removably secured into a shoe.

The user then re-attaches the shoe spacers 170a and 170b to the brackets 155a and 155b, respectively, in the direction 220, so that the shoes 160a/160b are removably secured to the rack 135. The user then slides in (pushes back) the rack 135 into the luggage 105. This sliding in movement will cause the sliding members 145a and 145b to slide into the base members 150a and 150b, respectively, in the direction 225. The user can then zip-up (close) the luggage 105, by moving the zipper 115 (FIG. 1) along the zipper track 116 so that the luggage cover 110 will completely close or cover any opening in the luggage 105.

FIG. 2 also shows the vertical member 140a (on rack 105) as having a base 241a mounted on and attached to the sliding member 145a and the vertical member 140b as having a base 241b mounted on and attached to the sliding member 145b, in one embodiment of the invention. In another embodiment of the invention, the vertical member 140a is integrated with the sliding member 145a, and the vertical member 140b is integrated with the sliding member 145b. Those skilled in the art will realize, after reading the discussion herein, that the assembly, manufacture, and/or construction of the components of the rack 135 may be selectively varied based on cost, ease of manufacturing, or/and other considerations.

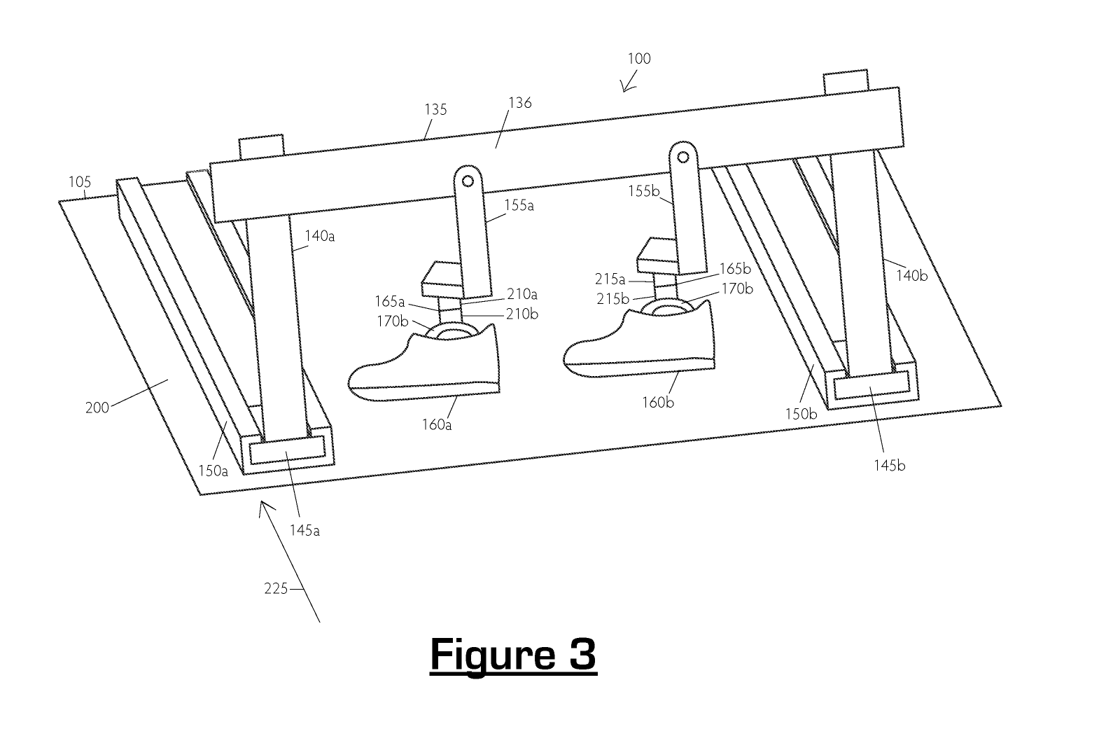

FIG. 3 is a side view of an apparatus 100 in accordance with an embodiment of the invention, where the shoe pieces 160a and 160b have been secured by the shoe spacers 170a and 170b, respectively. The user first attaches the shoe pieces 160a and 160b to the shoe spacers 170a and 170b, respectively, which are still detached from the brackets 155a and 155b, respectively. The user then attaches the shoe spacers 170a and 170b to the brackets 155a and 155b, respectively. Specifically, the user attaches the component 210b (on the shoe spacer 170a) to the component 210a on the bracket 155a, and attaches the component 215b (on the shoe spacer 170b) to the component 215a on the bracket 155b.

The user then slides in (pushes in) the rack 135 into the luggage 105, and this movement will cause the sliding members 145a and 145b to slide into the base members 150a and 150b, respectively, in the inward direction 225. The user will zip (close) the luggage 105 by use of the zipper 115 (FIG. 1).

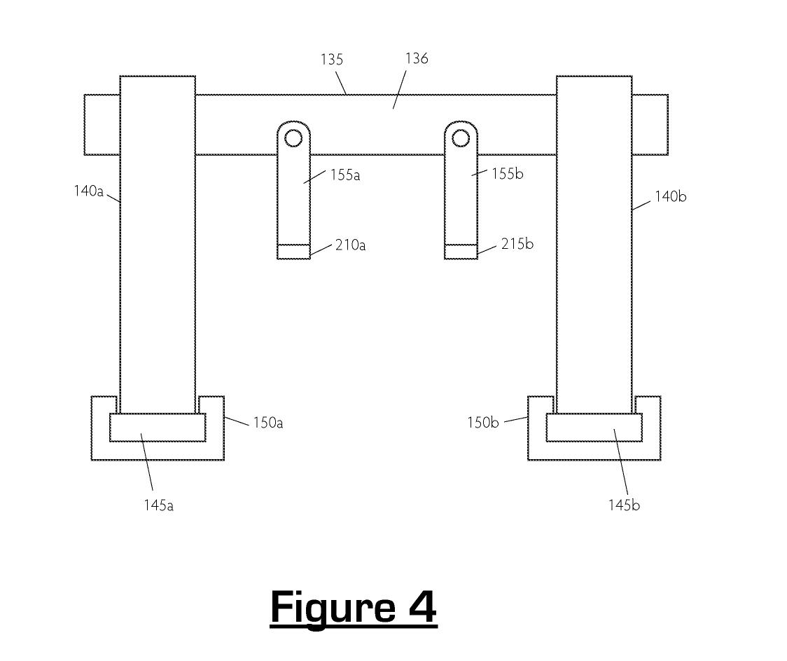

FIG. 4 is a side view of a rack 135 in accordance with an embodiment of the invention. In this example view, the shoe spacers 170a and 170b are not coupled to the brackets 155a and 155b. Additionally, the rack 135 is shown as detached from the luggage 105.

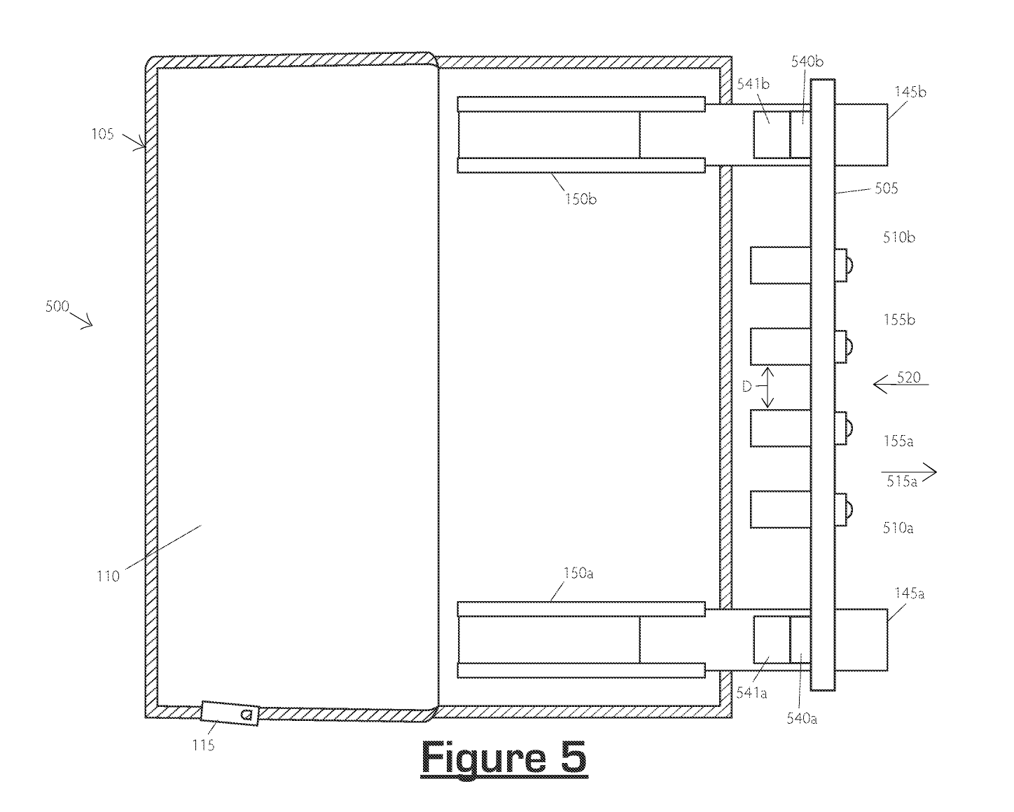

FIG. 5 is a top view of an apparatus 500 in accordance with another embodiment of the invention. The rack 505 includes more than two (2) brackets, as shown by the first and second brackets 155a/155b and additional third and fourth brackets 510a/510b that are coupled to the rack 505. Therefore, four (4) shoe pieces (or 2 pairs of shoes) can be removably coupled to the rack 505. The number of brackets coupled to the rack 505 may vary. In an embodiment of the invention, the brackets are separated from each other by a distance D so that the shoe pieces 160a/160b (FIG. 1) are not in contact with each other when the shoes are attached to adjacent brackets. As a non-limiting example, adjacent brackets are separated by a distance D of at least approximately 4.5 inches.

As in the rack 135 of FIG. 1, the rack 505 can slide away from the luggage 105 in the direction 515 and slide into the luggage 105 in the direction 520. The rack 505 also has the vertical members 540a and 540b that are attached by the base 541a and 541b to the sliding members 145a and 145b, respectively.

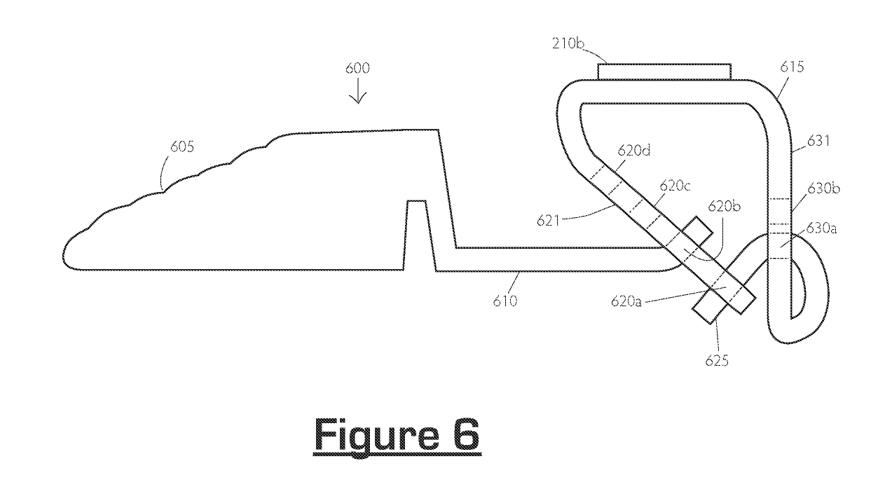

FIG. 6 is a side view of a shoe spacer 600 in accordance with an embodiment of the invention. This shoe spacer 600 can be attached to the racks discussed herein (e.g., racks 135 and 505). The shoe spacer 600 includes a front member 605 which is typically shaped similar to a shoe front portion. A rear member 610 is coupled to an adjustable member 615. The attachment component 210b (as similarly discussed above) is coupled to the adjustable member 615. It is noted that the shape and configuration of the shoe spacer 600 may be suitably varied so that the shoe spacer 600 can still be removably secured into an opening of a shoe.

To set the shoe spacer 600 at a first given size, the rear member 610 is removably attached to an aperture (opening) 620b along a left portion 621, while the end portion 625 is removably attached to the aperture 620a along the left portion 621 and to the aperture 630a on the right portion 631. It is noted that the left portion 621 can include other apertures such as the aperture 620c and 620d and the right portion 631 can include other apertures such as the aperture 630b, so that the size of the shoe spacer 600 is adjustable to fit different size shoes such as, for example, different sizes of adult shoes and various sizes of children shoes.

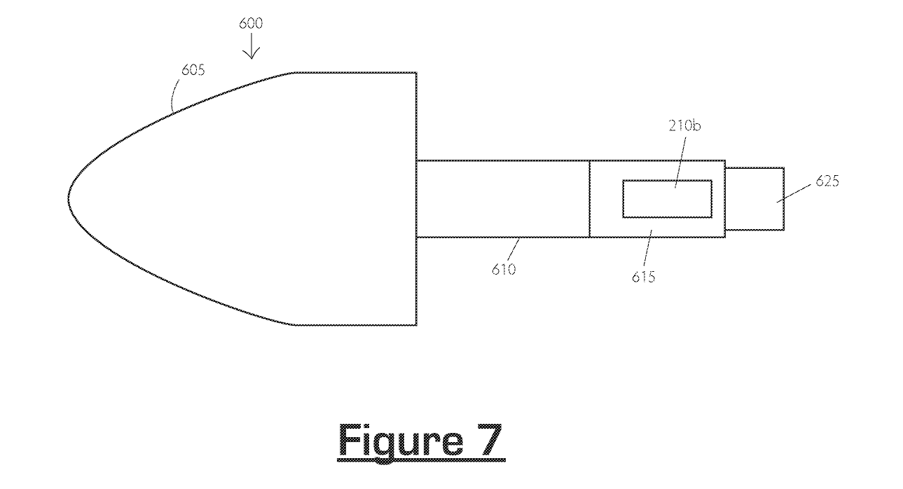

FIG. 7 is a top view of the shoe spacer 600 of FIG. 6, in accordance with an embodiment of the invention.

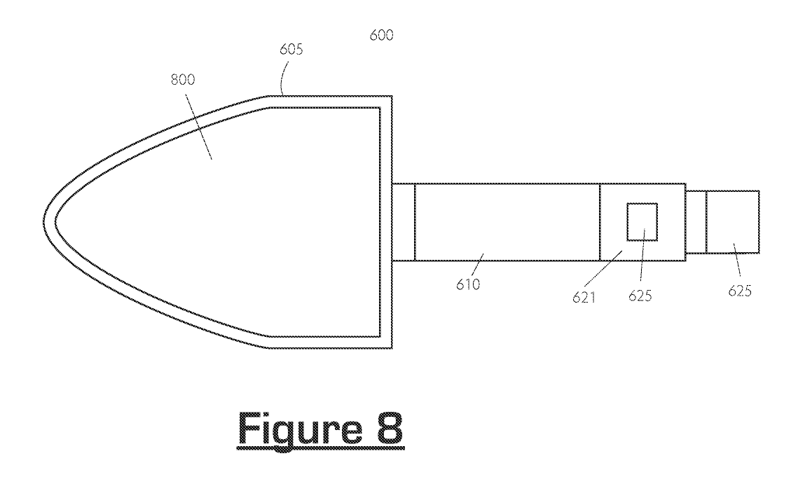

FIG. 8 is a bottom view of the shoe spacer 600 of FIG. 6, in accordance with an embodiment of the invention. The front member 605 can include a domed or hollow section 800 for purposes of saving material or reducing weight of the shoe spacer 600.

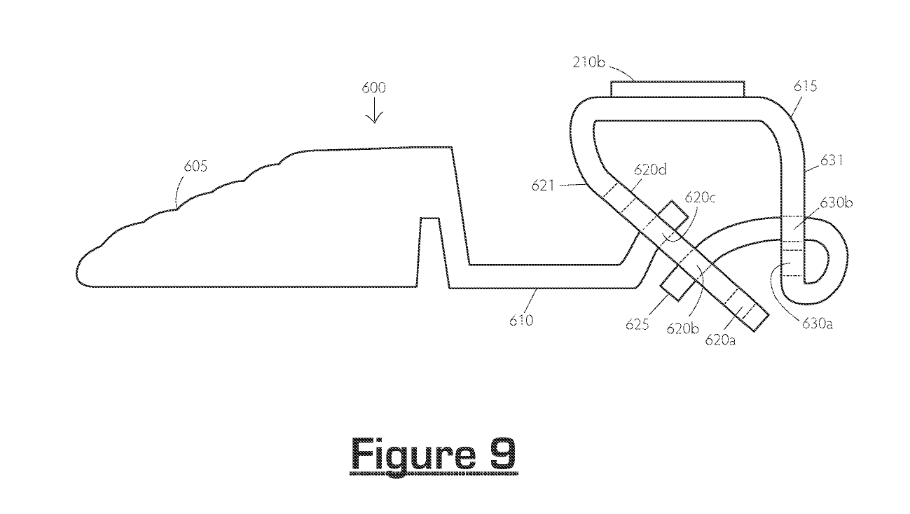

FIG. 9 is a side view of the shoe spacer 600 of FIG. 6 in accordance with an embodiment of the invention, where the size of the shoe spacer 600 has been adjusted. The size of the shoe spacer 600 is adjusted in FIG. 9 by removably attaching the rear member 610 to the aperture 620c and removably attaching the end portion 625 into the aperture 620b in the left portion 621 and the aperture 630b in the right portion 631. Therefore, the apertures in the left portion 621 and the right portion 631 are used for purposes of varying or adjusting the size of the shoe spacer 600 to fit into different sizes of shoes. It is noted that other types of adjustment mechanisms may be used to vary the size of the shoe spacer 600.

FIG. 10 is a cross-section view of a shoe piece 160 with a shoe spacer 600 that is removably inserted and removably secured in the shoe piece 160, in accordance with an embodiment of the invention. The shoe spacer 600 is inserted into the shoe piece 160 so that the shoe spacer 600 is removably secured in the inside portion 1005 of the shoe piece 160. The front member 605 is secured in the front portion 1010 of the shoe piece 160 and the adjustable member 615 is secured in the rear portion 1015 of the shoe piece 160. The attachment component 210b (of the shoe spacer 600) is removably coupled to the attachment component 210a (of the bracket 155a that is coupled to the rack 135). Therefore, the shoe piece 160 is secured to the rack 135 in a static position.

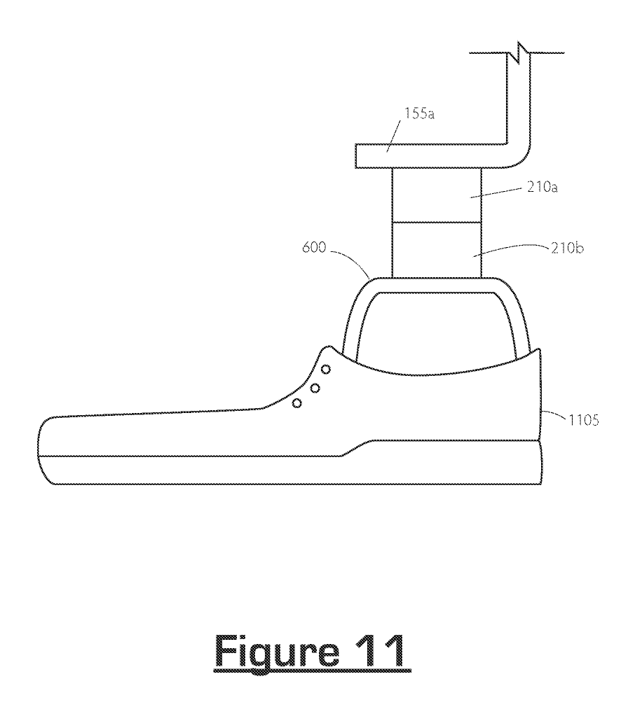

FIG. 11 is a side view of a men-shoe type 1105 that is removably secured to a shoe spacer 600 and bracket 155a in a rack (e.g., rack 135 in FIG. 1), in accordance with an embodiment of the invention. The shoe type 1105 can be any shoes for men such as, for example, walking shoes, dress shoes, boots, or other types of footwear. The shoes can be made of conventional materials such as, for example, leather, vinyl, acrylic, suede, or other types of materials. The shoe spacer 600 is adjustable in size to removably secure the shoe type 1105. As discussed above, the shape of the shoe spacer 600 is flexible, variable, and adjustable, in order to removably insert and removably secure the shoe spacer 600 into a shoe piece. FIG. 11 shows a non-limiting example of the shape of the shoe spacer 600 that is inserted into a shoe piece. It is understood by those skilled in the art that the shape of the shoe spacer 600 may vary depending on the size and/or type of shoe piece that removably receives the shoe spacer 600.

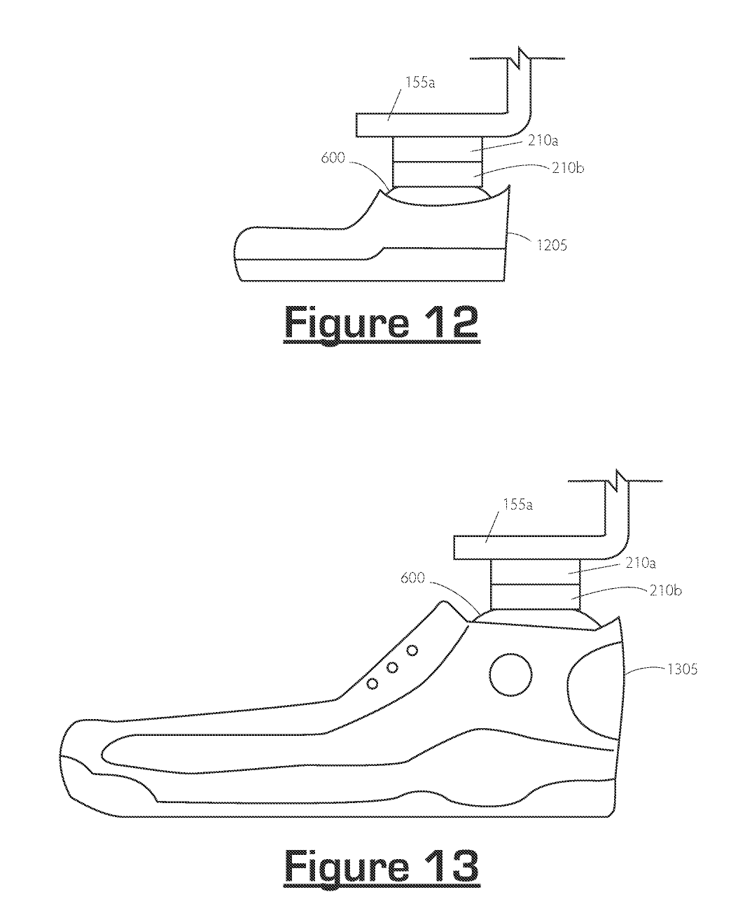

FIG. 12 is a side view of a children-shoe type 1205 that is removably secured to a shoe spacer 600 and bracket 155a in a rack (e.g., rack 135 in FIG. 1), in accordance with an embodiment of the invention. The shoe type 1205 can be any shoes for children such as, for example, walking shoes, dress shoes, boots, or other types of footwear. The shoes can be made of conventional materials such as, for example, leather, vinyl, acrylic, suede, or other types of materials. The shoe spacer 600 is adjustable in size to removably secure the shoe type 1205 which is smaller in size than the adult-sized shoe type 1105 of FIG. 12.

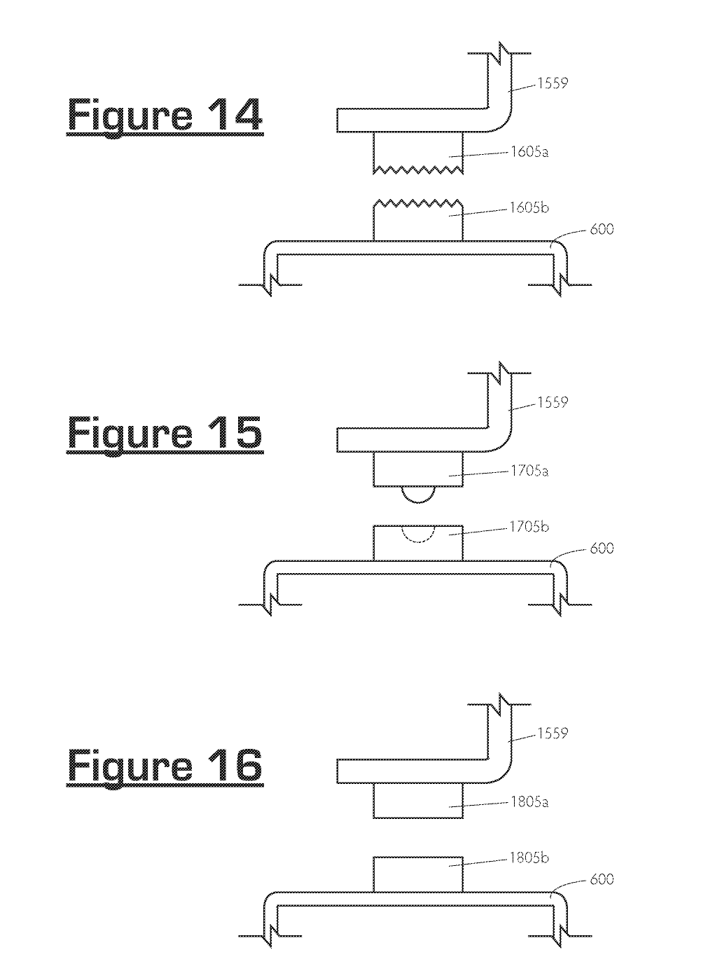

FIG. 13 is a side view of an athletic-shoe type 1305 that is removably secured to a shoe spacer 600 and bracket 155a in a rack (e.g., rack 135 in FIG. 1), in accordance with an embodiment of the invention. The shoe type 1305 can be any type of athletic shoes such as, for example, low-top (or mid-top or high-top) basketball shoes, running shoes, cross-trainers, walking shoes, baseball shoes, hockey footwear, or other types of athletic footwear. The shoes can be made of conventional materials such as, for example, leather, vinyl, acrylic, suede, or other types of materials. The shoe spacer 600 is adjustable in size to removably secure the shoe type 1305.

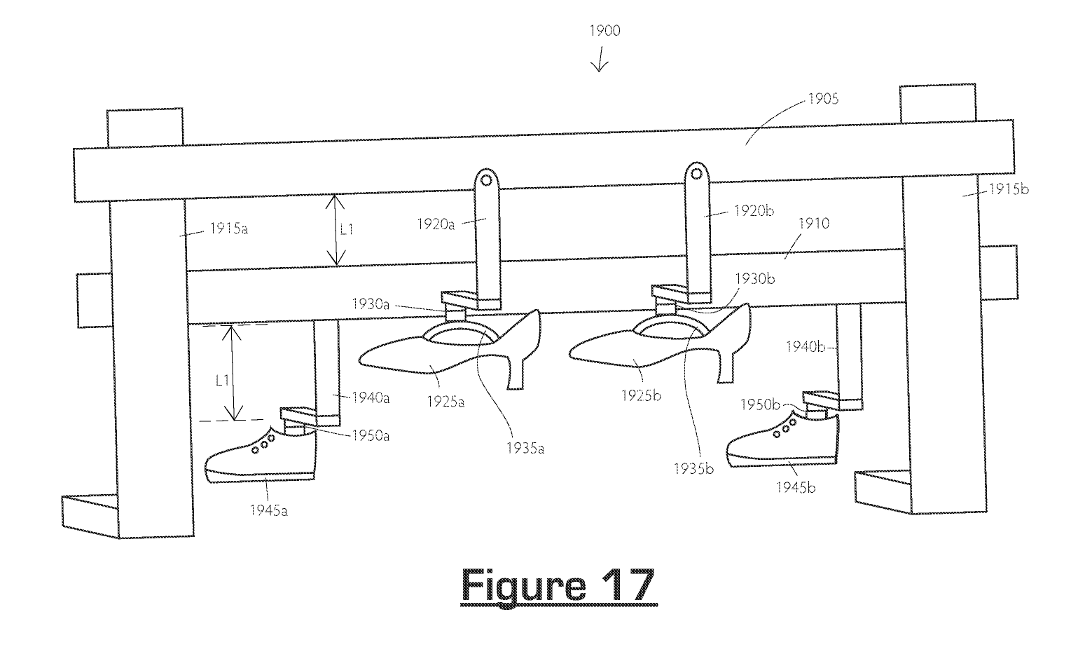

FIG. 14 is a side view of an attachment mechanism 1605a/1605b for removably coupling the shoe spacer 600 with the rack (e.g., rack 135), in accordance with an embodiment of the invention. Specifically, the attachment mechanism component 1605a is coupled to a bracket (e.g., bracket 155a) of the rack and the attachment mechanism component 1605b is coupled to the shoe spacer 600. The component 1605a and component 1605b are, for example, Velcro parts that can be removably attached to each other.

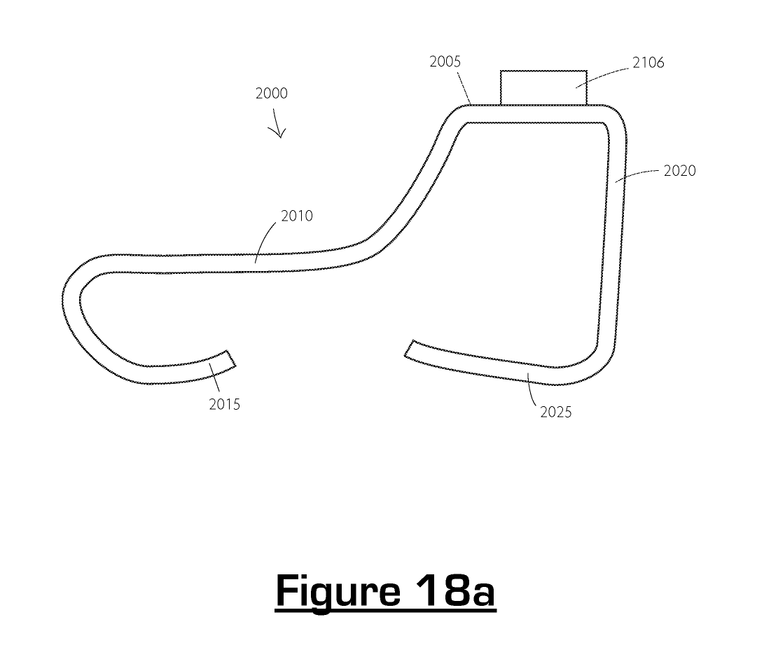

FIG. 15 is a side view of an attachment mechanism 1705a/1705b for removably coupling the shoe spacer 600 with the rack (e.g., rack 135), in accordance with another embodiment of the invention. Specifically, the attachment mechanism component 1705a is coupled to a bracket (e.g., bracket 155a) of the rack and the attachment mechanism component 1705b is coupled to the shoe spacer 600. The component 1705a and component 1705b are buttons or a ball-pin lock that can be removably attached to each other, or other suitable snap-on or snap-together locking mechanisms for removably coupling two components together.

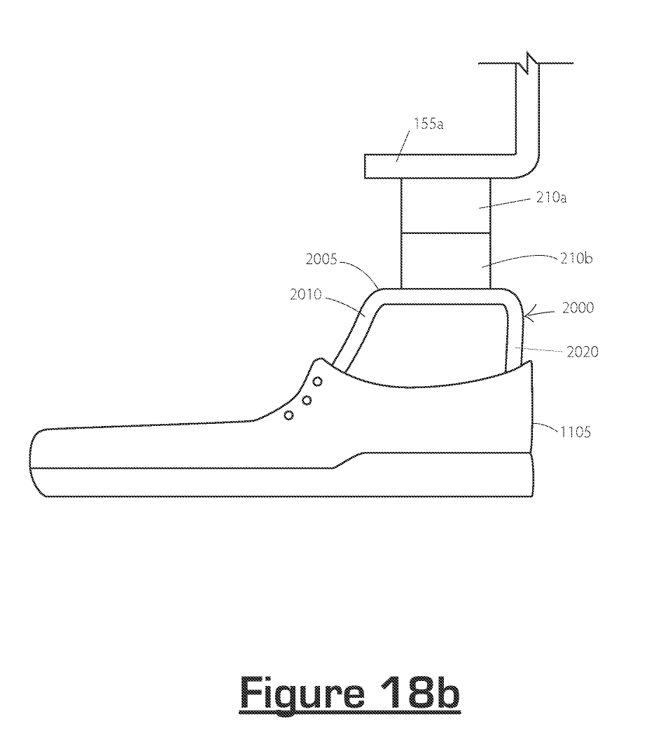

FIG. 16 is a side view of an attachment mechanism 1805a/1805b for removably coupling the shoe spacer 600 with the rack (e.g., rack 135), in accordance with another embodiment of the invention. Specifically, the attachment mechanism component 1805a is coupled to a bracket (e.g., bracket 155a) of the rack and the attachment mechanism component 1805b is coupled to the shoe spacer 600. The component 1805a and component 1805b are high strength magnet components or other attachment mechanisms that can be removably attached to each other.

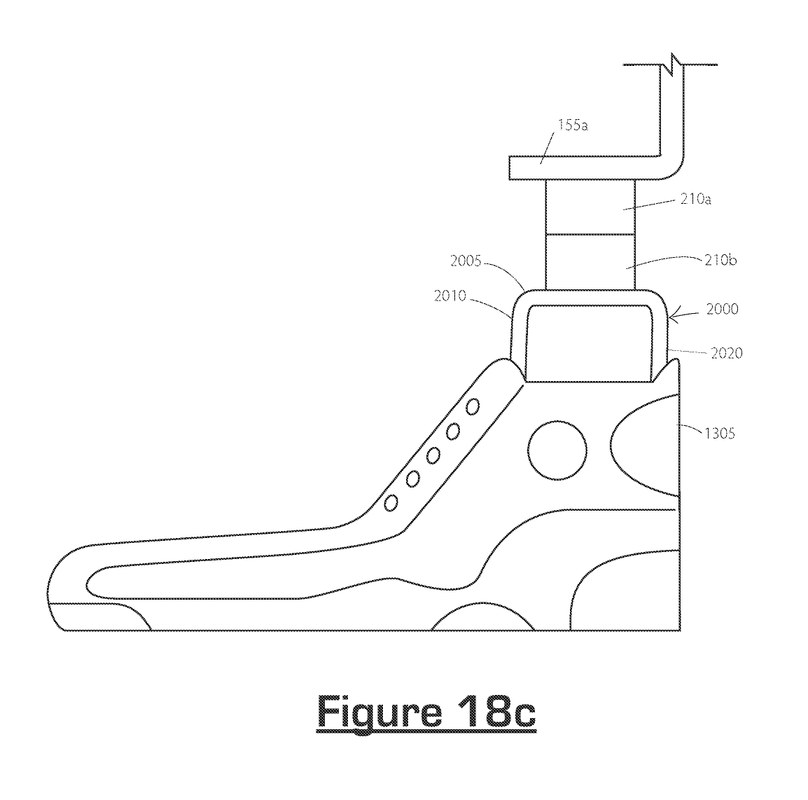

FIG. 17 is a side view of a rack 1900 in accordance with another embodiment of the invention. The rack 1900 includes a first horizontal member 1905 and a second horizontal member 1910. Both members 1905 and 1910 are coupled to the vertical members 1915a/1915b.

The brackets 1920a/1920b are coupled to the first horizontal member 1905. A shoe piece 1925a can be attached to a shoe spacer 1935a which is removably coupled by attachment mechanism 1930a to the bracket 1920a. The other shoe piece 1925b can be attached to a shoe spacer 1935b which is removably coupled by attachment mechanism 1930b to the bracket 1920b.

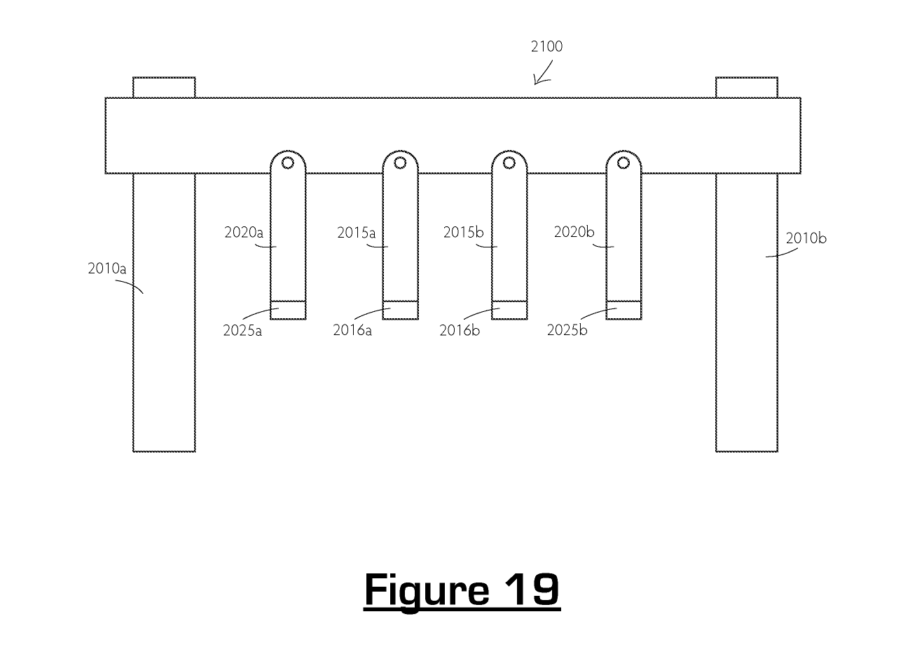

The brackets 1940a/1940b are coupled to the second horizontal member 1910. A shoe piece 1945a can be attached to a shoe spacer (not shown in FIG. 19) which is removably coupled by attachment mechanism 1950a to the bracket 1940a. The other shoe piece 1945b can be attached to a shoe spacer (not shown in FIG. 19) which is removably coupled by attachment mechanism 1950b to the bracket 1940b.

The horizontal members 1905 and 1910 are offset vertically by a distance L1. Consequently, the bottom of the brackets 1940a/1940b are offset by the same distance L1 from the bottom of the brackets 1920a/1920b. Therefore, the shoe pair 1925a/1925b (which can be women shoes with heels) can be placed higher vertically than the shoe pair 1945a/1945b (which can be men shoes). Therefore, higher heeled shoes can be removably coupled to the higher horizontal member 1905 and still fit within the luggage.

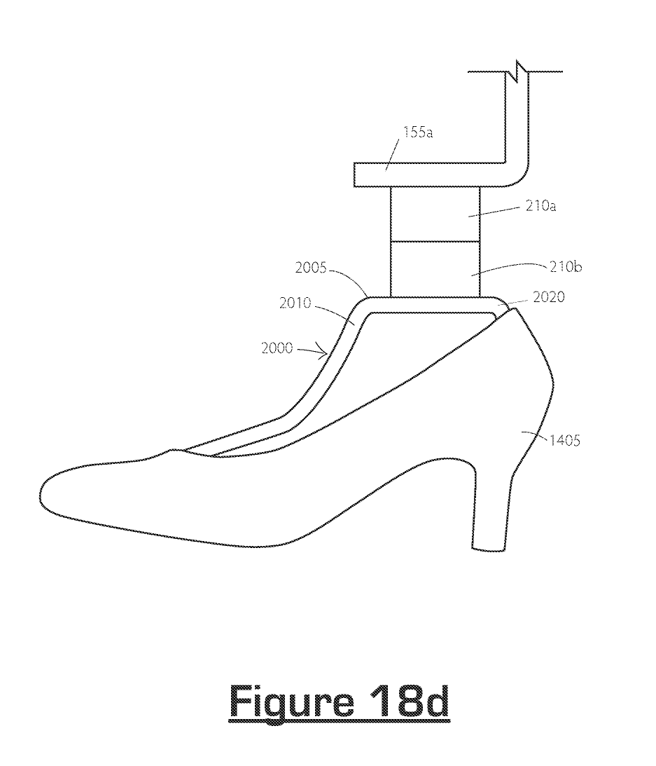

FIG. 18A is a side view of a shoe spacer 2000 in accordance with another embodiment of the invention. The shoe spacer 2000 includes a top member 2005, a top front member 2010 which is integrated with the top front member 2005, a bottom front member 2015 which is integrated with the top front member 2010, a rear member 2020 which is integrated with the top member 2005, and bottom rear member 2025 which is integrated with the rear member 2020. An attachment component 210 (which has been discussed above in various embodiments) is mounted or attached on the top member 2005. The members (parts) 2005, 2010, 2015, 2020, and 2025 are flexible and sufficiently firm so that the shoe spacer 2000 is adjustable in size and can be removably inserted into and removably secured with different sizes and different types of shoes. As an example, the parts of the shoe spacer 2000 can be flexible rubber, flexible plastic, flexible synthetic material, or other flexible and sufficiently firm material that can securely hold a shoe piece.

FIG. 18B is a side view of a men-shoe type 1105 that is removably secured to a shoe spacer 2000 as discussed above and bracket 155a in a rack, in accordance with another embodiment of the invention. As discussed above, the shoe type 1105 can be any shoes for men such as, for example, walking shoes, dress shoes, boots, or other types of footwear. The shoe spacer 2000 is adjustable in size to removably secure the shoe type 1105

FIG. 18C is a side view of an athletic-shoe type 1305 that is removably secured to a shoe spacer 2000 as discussed above and bracket 155a in a rack, in accordance with another embodiment of the invention. As discussed above, the shoe type 1305 can be any type of athletic shoes such as, for example, low-top (or mid-top or high-top) basketball shoes, running shoes, cross-trainers, walking shoes, baseball shoes, hockey footwear, or other types of athletic footwear. The shoe spacer 2000 is adjustable in size to removably secure the shoe type 1305.

FIG. 18D is a side view of a women-shoe type 1405 that is removably secured to a shoe spacer 2000 as discussed above and bracket 155a in a rack, in accordance with another embodiment of the invention. As discussed above, the shoe type 1405 can be any shoes for women such as, for example, walking shoes, dress shoes, boots, high-heels, evening shoes, or other types of footwear. The shoe spacer 2000 is adjustable in size to removably secure the shoe type 1405. As shown in FIGS. 20A to 20D, the shoe spacer 2000 is adjustable and variable in shape and size, depending on the size or/and type of shoe that is removably secured to the shoe spacer 2000.

FIG. 19 is a side view of a rack 2100 in accordance with another embodiment of the invention. The rack 2100 includes the horizontal member 2105 which is attached to the vertical members 2110a/2110b. The bracket 2115a (with attachment component 2116a) and bracket 2115b (with attachment component 2116b) have the same length. The bracket 2120a (with attachment component 2125a) and bracket 2120b (with attachment component 2125b) have the same length as the brackets 2120a and 2120b. The brackets 2115a/2115b and 2120a/2120b can be attached to the rack 2100 by attachment mechanisms as previously discussed above or can be integrated with the rack 2100.

In another embodiment of the invention, a method of assembling a footware traveler includes: providing a rack including a horizontal member and vertical members; attaching the vertical members on a sliding member; mounting the sliding member on a base member; attaching brackets on the horizontal member; providing shoe spacers; and attaching an attachment mechanism on the brackets and the shoe spacers, wherein the shoe spacers are removably coupled to the rack by the attachment mechanism. The various components in the above method have been previously described above.

Other variations and modifications of the above-described embodiments and methods are possible in light of the teaching discussed herein.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus comprising:
a portable item storage device;
a rack disposed in the portable item storage device; and
a first shoe spacer and a second shoe spacer, each shoe spacer removably coupled to the rack and adjustable in size.

2. The apparatus of claim 1, wherein the first shoe spacer is removably securable to a first shoe piece and the second shoe spacer is removably securable to a second shoe piece.

3. The apparatus of claim 1, further comprising:
a first bracket coupled between the rack and the first shoe spacer; and
a second bracket coupled between the rack and the second shoe spacer, wherein the first shoe spacer is removably coupled to the first bracket and the second shoe spacer is removably coupled to the second bracket.

4. The apparatus of claim 3, further comprising:
a first attachment mechanism for removably coupling the first shoe spacer to the first bracket; and
a second attachment mechanism for removably coupling the second shoe spacer to the second bracket.

5. The apparatus of claim 1, further comprising:
a base member;
a sliding member coupled to the rack and configured to slide on the base member, so that the rack is slidable at various positions with respect to the portable item storage device.

6. The apparatus of claim 1 wherein the portable item storage device comprises a luggage.

7. The apparatus of claim 1, wherein the rack further comprises:
a third shoe spacer;
a fourth shoe spacer;
a third bracket coupled between the rack and the third shoe spacer; and
a fourth bracket coupled between the rack and the fourth shoe spacer, wherein the third shoe spacer is removably coupled to the third bracket and the fourth shoe spacer is removably coupled to the fourth bracket.

8. The apparatus of claim 7, wherein the first bracket and second bracket are offset by a distance from the third bracket and the fourth bracket.

9. The apparatus of claim 7, wherein a first pair of shoes are removably coupled to the first and second shoe spacers and are offset by a distance from a second pair of shoes that are removably coupled to the third and fourth shoe spacers.

10. The apparatus of claim 1, wherein the shoe spacer is configured to fit into different sizes of shoes.

11. The apparatus of claim 1, wherein the shoe spacer comprises an ankle member.

12. A method of assembling a footware traveler comprises:
providing a rack including a horizontal member and vertical members;
attaching the vertical members on a sliding member;
mounting the sliding member on a base member;
attaching brackets on the horizontal member;
providing shoe spacers; and
attaching an attachment mechanism on the brackets and the shoe spacers, wherein the shoe spacers are removably coupled to the rack by the attachment mechanism.

13. An apparatus comprising:
a rack; and
a first shoe spacer and a second shoe spacer, each shoe spacer removably coupled to the rack and adjustable in size.

14. The apparatus of claim 13, wherein the first shoe spacer is removably securable to a first shoe piece and the second shoe spacer is removably securable to a second shoe piece.

15. The apparatus of claim 13, further comprising:
a first bracket coupled between the rack and the first shoe spacer; and
a second bracket coupled between the rack and the second shoe spacer, wherein the first shoe spacer is removably coupled to the first bracket and the second shoe spacer is removably coupled to the second bracket.

16. The apparatus of claim 17, further comprising:
a first attachment mechanism for removably coupling the first shoe spacer to the first bracket; and
a second attachment mechanism for removably coupling the second shoe spacer to the second bracket.

17. The apparatus of claim 13, further comprising:
a base member;
a sliding member coupled to the rack and configured to slide on the base member, so that the rack is slidable at various positions.

18. The apparatus of claim 13, wherein the rack further comprises:
a third shoe spacer;
a fourth shoe spacer;
a third bracket coupled between the rack and the third shoe spacer; and
a fourth bracket coupled between the rack and the fourth shoe spacer, wherein the third shoe spacer is removably coupled to the third bracket and the fourth shoe spacer is removably coupled to the fourth bracket.

19. The apparatus of claim 18, wherein the first bracket and second bracket are offset by a distance from the third bracket and the fourth bracket.

20. An apparatus comprising;
a rack; and
first means for providing a shoe spacer; and
second means for providing a shoe spacer, each of said first means and second means coupled to the rack and adjustable in size.
